(19) United States
(12) Patent Application Publication
(10) Pub. No.: US 2006/0277850 A1
(43) Pub. Date: Dec. 14, 2006

(54) Partition panel assembly

(76) Inventors: Donald P. Gravel, North York (CA); Oxana Robertson, Concord (CA)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/147,503

(22) Filed: Jun. 8, 2005

(51) Int. Cl. E06B 3/32; E04H 1/00

(52) U.S. Cl. 52/204.51; 52/243.1

(57) ABSTRACT

A partition panel assembly includes a stationary panel member having an exposed surface including a longitudinally-extending, downwardly-exposed channel, and a door member slidably supported from the stationary panel member for movement between a closed position and an open position. The partition panel assembly also includes a door member support assembly comprising a roller assembly operably coupled to the door member, and a support member having an upwardly-extending arm received within the channel of the stationary panel member, a downwardly-extending arm abutting the exposed surface of the stationary panel member, and a track member supporting the roller of the roller assembly such that the door member is slidably supported from the stationary panel member. The partition panel assembly further includes a decelerator assembly including a spring member secured to the track member and adapted to frictionally engage the door member when the door member is proximate the open or closed position, thereby decreasing a velocity of the door member prior to the door member reaching a fully opened or closed position.

### BACKGROUND OF THE INVENTION

The present invention relates to a partition panel assembly that defines an ingress and egress opening therein and includes a door slidable between an open and closed position, and in particular a reduced-part door member support assembly and decelerator assembly.

Typically, both the freestanding and the floor-to-ceiling partition panel assemblies define ingress and egress openings therein through which users migrate between private workstations and common work areas. In order to provide privacy in the workstations or to groups within common work areas, doors are typically provided in order to cover the openings or doorways defined within the partition panel assembly. These doors are commonly pivotally hinged at one side thereof, or slidably supported by a track assembly.

Heretofore, the track assemblies commonly used are typically complicated in design involving a significant number of components and parts. These complicated designs may require skilled personnel to install. Further, these designs that include numerous parts are expensive to manufacture, package and ship to the appropriate destination for installation. Moreover, many of these designs allow the sliding door to directly abut a permanent structural component of the partition panel assembly, thereby defining the fully open or closed position of the door. These configurations allow the transmission of significant impact forces from the door to the structural component when the door reaches the fully open or closed position, thereby resulting in structural degradation of the overall assembly, adding to the noise levels in the associated work area, etc.

Therefore, a partition panel assembly is desired that provides for a reduced-part support track assembly that provides an ease of installation. Further, a partition panel assembly is desired that slows the velocity of a door member slidably supported within the partition panel assembly, prior to the door member reaching a fully open or closed position.

### SUMMARY OF THE INVENTION

One aspect of the present invention is to provide a partition panel assembly defining an ingress and egress opening therein, and comprising a stationary panel member having an exposed surface, wherein the exposed surface includes a longitudinally-extending, downwardly-exposed channel, and a door member slidably supported from the stationary panel member for movement between a closed position, wherein the door member covers the ingress and egress opening of the partition panel assembly, and an open position, wherein the door member allows ingress and egress through the opening. The partition panel assembly also includes a door member support assembly that comprises a roller assembly operably coupled to the door member and including at least one roller, and a support member having an upwardly-extending arm received within the channel of the panel member, a downwardly-extending arm abutting the exposed surface of the stationary panel member, and a track member supporting the roller of the roller assembly such that the door member is slidably supported from the stationary panel member.

Another aspect of the present invention is to provide a sliding door support assembly adapted to slidably support a door member from a stationary partition panel such that the door member is supported from the stationary panel member for movement between a closed position, wherein the door members cover an ingress and egress opening adjacent the stationary partition panel, and an open position, wherein the door member allows ingress and egress through the opening, the sliding door assembly comprising a roller assembly including at least one roller, and an adjustment assembly operably adapted to couple a door member with the roller assembly, wherein the adjustment assembly is adjustable to allow leveling of the door member with respect to a horizontal plane. The sliding door support assembly further includes a support member having an upwardly-extending arm received within a downwardly-exposed channel of a stationary panel member, a downwardly-extending arm abutting the stationary panel, and a track member supporting the at least one roller of the roller assembly.

Yet another aspect of the present invention is to provide a partition panel assembly that comprises a stationary panel member, a door member having an exposed surface, and a track member supported by the stationary panel member. The partition panel assembly also includes a support assembly slidably supporting the door member from the track member between a fully-open position and a fully-closed position. The partition panel assembly further includes a decelerator assembly including a spring member secured to the track member and adapted to frictionally engage the exposed surface of the door member when the door member is proximate a select one of the fully-open position and the fully-closed position, thereby decreasing a velocity of the door member prior to the door member reaching the select one of the fully-open position and the fully-closed position.

Still yet another aspect of the present invention is to provide a decelerator assembly adapted to slow the sliding movement of a door member slidably supported from a track member supported by a stationary panel member as the door member approaches a select one of a fully-open position and a fully-closed position, the decelerator assembly comprising a body portion adapted to be secured directly to the track member, and a spring member operably coupled with the body portion and adapted to frictionally engage an exposed surface of the door member when the door member is proximate a select one of a fully-open position and a fully-closed position, thereby decreasing a velocity of the door member prior to the door member reaching the select one of the fully-open position and the fully-closed position.

The present inventive partition panel assembly reduces the number of parts typical of support track assemblies associated with partition panel assemblies, and further reduces the skill required for installation thereof. Moreover, the present inventive partition panel assembly reduces the velocity of an included sliding door, thereby reducing noise associated with operation of the door and increasing the operating life of components of the partition panel assembly.

### BRIEF DESCRIPTION OF THE DRAWINGS

FIG. 1 is a perspective view of the partition panel assembly defining the present invention;

FIG. 2 is a cross-sectional view of a stationary panel member, a door member and a door member support assembly of the partition panel assembly, taken along the line II-II, FIG. 1;

FIG. 3 is a perspective view of a decelerator assembly;

FIG. 4 is a cross-sectional end view of a track member of the door member support assembly taken along the line IV-IV, FIG. 1, and illustrating the decelerator assembly mounted within the track member;

FIG. 5 is a perspective view of the door member supported within the door member support assembly, wherein the door is in a partially open position; and

FIG. 6 is a perspective view of the door member supported within the door member support assembly, wherein the door member is in a fully open position.

### DETAILED DESCRIPTION OF THE PREFERRED EMBODIMENTS

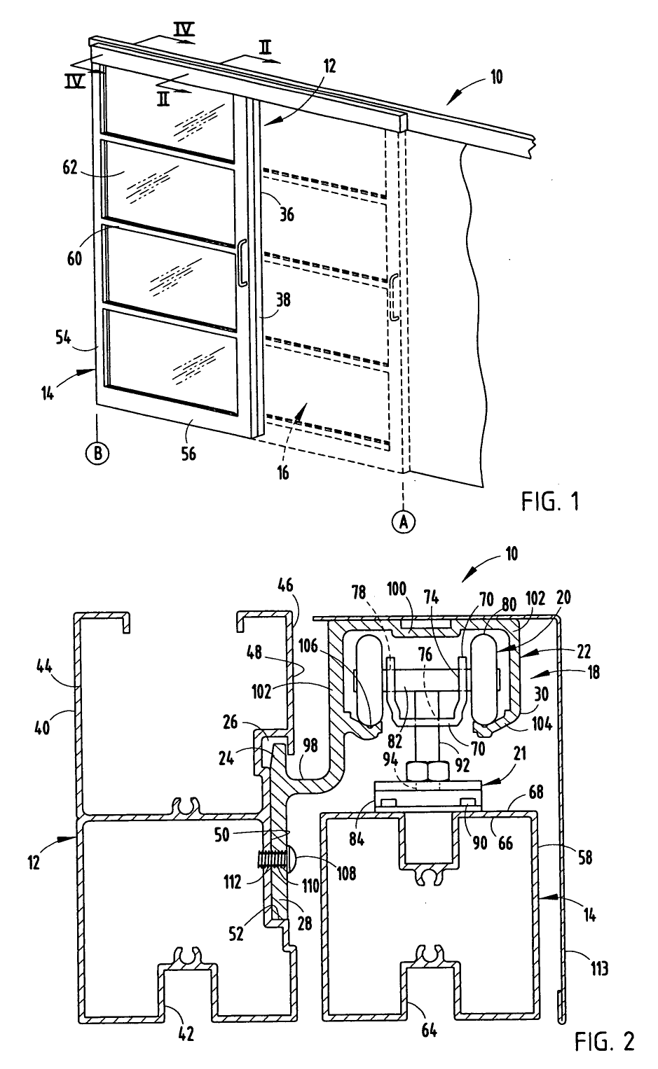

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

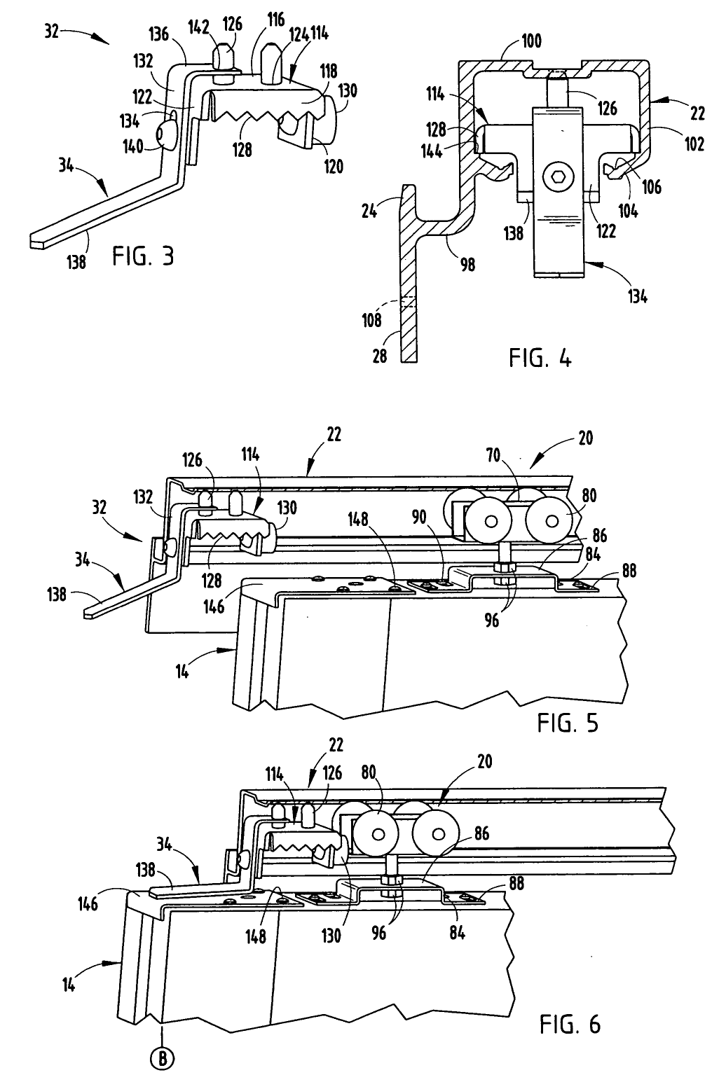

The reference numeral 10 (FIG. 1) generally designates the partition panel assembly embodying the present invention. In the illustrated example, the partition panel assembly 10 includes a stationary panel member 12, a door member 14 slidably supported by the stationary panel member for movement between a closed position, wherein the door member 14 covers an ingress and egress opening defined by the partition panel assembly 10 and located adjacent the stationary panel member 12, and an open position B, wherein the door member 14 allows ingress and egress through the opening 16. The partition panel assembly 10 (FIG. 2) further comprises a door member support assembly 18 that includes a roller assembly 20, an adjustment assembly 21 operably coupling the door member 14 with the roller assembly 20 wherein the adjustment assembly 21 is adjustable to allow leveling of the door member 14 with respect to the stationary panel member 12, and a support member 22 having an upwardly-extending arm 24 received within a downwardly-exposed channel 26 of the stationary panel member 12, a downwardly-extending arm 28 abutting the stationary panel member 12, and a track portion 30 supporting the roller assembly 20 such that the door member 14 is slidably supported from the stationary panel member 12. The partition panel assembly further includes a decelerator assembly 32 (FIG. 3) including a spring member 34 secured to the support member 22 and adapted to frictionally engage the door member 14 when the door member 14 is proximate either the fully-closed position A or the fully-open position B, thereby decreasing a velocity of the door member 14 prior to the door member 14 reaching the select one of the fully-closed position A or the fully-open position B.

The stationary panel member 12 comprises an outer frame assembly 36 that includes vertical frame members 38, a bottom frame member (not shown), and a top frame member 40. In the illustrated example, the top frame member 40 includes a downwardly-exposed channel 42 adapted to receive glass panels, solid panels, and the like therein, an inner sidewall 44 and an outer sidewall 46. The outer sidewall 46 includes an outer surface 48 and a recess 50 extending into the outer surface 48 and longitudinally along the top frame member 40. The channel 26 extends longitudinally along the top frame member 40, is downwardly exposed, and is positioned so as to communicate with the recess 50. The recess 50 defines a lower wall extending longitudinally along the top frame member 40 and positioned opposite the channel 26 across the recess 50.

The door member 14 includes a pair of vertically-extending side frame members 54, a horizontally-extending bottom frame member 56, a horizontally-extending top frame member 58, a plurality of horizontally-extending mid-height frame members 60 and a plurality of panel insert members 62 interspaced with the bottom frame member 56, the top frame member 58 and the mid-height frame members 60. The top frame member 58 includes a downwardly-exposed channel 64 that receives one of the panel insert members 62 therein, and a top wall 66 defining a top surface 68. The panel insert members 62 may include glass panels, solid or opaque panels, and the like.

The roller assembly 20 of the door member support assembly 18 includes a U-shaped body member 70 having a bottom wall 72 and a pair of sidewalls 74 extending orthogonally upward from the bottom wall 70. The bottom wall 70 includes an aperture 76 while the sidewalls 74 each include a pair of apertures 78. The roller assembly 20 further includes a plurality of rollers 80 pivotally coupled to the body member 70 by a pair of axles 82 that extend through the apertures 78 of the sidewalls 74. Each adjustment assembly 21 of the door member support assembly 18 includes a hat-shaped coupler 84 (FIG. 5) having a top wall 86 and a pair of fastening legs 88 offset from the top wall 86. The coupler 84 is fixedly attached to the top wall 66 of the top frame member 58 by a plurality of screws 90. Each adjustment assembly 21 further includes a threaded shaft 92 secured within the apertures 76 of the bottom wall 72 of the body member 70, and extending downwardly therefrom. The shaft 92 of each adjustment assembly 21 is received within an aperture 94 extending through the top wall 86 of the coupler 84, and is held in place by a pair of lock nuts 96 placed above and below the top wall 86, respectively. The relative position of the lock nuts 96 along the length the shaft 92 may be adjusted, thereby adjusting the relative distance between the coupler 84 and the roller assembly 20 and the relative horizontal orientation of the door member 14 with respect to the stationary panel 12 and a horizontal plane.

The support member 22 of the door member support assembly 18 includes the upwardly-extending arm 24, the downwardly-extending arm 28 and the track portion 30, and comprises an extruded, single-piece construction. An extension portion 98 extends outwardly and upwardly from the arms 24, 28 and is integrally formed with the track portion 30. The track portion 30 includes an elongated upper wall 100, a pair of elongated sidewalls 102, and a pair of J-shaped track rails 104 each defining an upwardly opening channel 106. In assembly, the upwardly-extending arm 24 of the support member 22 is inserted upwardly into the channel 26 of the top frame member 40. The downwardly-extending arm 28 of the support member 22 is then pivoted towards the top frame member 40 until the arm 28 is located within the recess 50 and abuts the top frame member 40 and the lower wall 52 of the recess 50. A plurality of screws 108 are then inserted into apertures 110 spaced longitudinally along the arm 28 and a plurality of apertures 112 spaced longitudinally along the top frame member 40, thereby securing the support member 22 to the top frame member 40. The rollers 80 of the roller assembly 20 are then inserted into the support member 20 such that the rollers 80 roll and guide within the channels 106.

The spring member 34 (FIG. 3) of the decelerator assembly 32 is operably coupled to a body member 114 having a top wall 116, a pair of downwardly-extending sidewalls 118, a downwardly-extending front wall 120, and a downwardly-extending rear wall 122. The top wall 116 includes a pair of apertures 124 each threadably receiving a set screw 126 therein. Each side wall 118 includes a plurality of engagement teeth spaced longitudinally therealong. A elastically-deformable bumper is affixed to an outer surface of the front wall 120. The spring member 34 includes a body portion 132 having an elongated aperture 134 extending therethrough, a top leg 136 extending orthogonally from the body portion 132 and extending along the top wall 116 of the body member 114, and a flexibly resilient bottom leg 138 extending angularly downward from the body portion 132. In the illustrated example, the spring member 34 comprises a leaf spring, however, it should be noted that other spring-types may be used in place thereof. The spring member 34 is coupled to the body member 114 by an adjustment screw 140 that extends through the aperture 134 of the body portion 132 and is threadably received within an aperture (not shown) extending through the rear wall 122 of the body member 114. A U-shaped notch, 142 located in a distal end of the top leg 136 is co-aligned with and held in position by one of the set screws 126.

As best illustrated in FIG. 4, the decelerator assembly 32 is coupled with the support member 22 by inserting the body member 114 into the support member 22 such that the teeth 128 of each sidewall 118 rests upon a longitudinally-extending ledge 144 located between the sidewalls 102 and the track rails 104. The set screws 126 are then threaded upwardly until each set screw 126 abuts the upper wall 100 of the support member 22, thereby forcing engagement of the teeth 128 with the associated ledges 144 and fixing the location of the decelerator assembly 32 with respect to the support member 22.

In operation, the decelerator assembly 32 is positioned within the support member 22 such that the bottom leg 138 of the spring member 34 extends downwardly below the top surface 68 of the top wall 66 of the door member 14. In the illustrated example, as the door member 14 approaches the fully open position B (FIG. 6), the bottom leg 138 of the spring member 34 frictionally abuts a plate member 146 fixedly attached to the top wall 66 of the door member 14 by a plurality of screws 148, thereby slowing the velocity of the door member 14 as it approaches the fully open position. It should be noted that the decelerator assembly 138 may be configured and positioned so as to abut a surface of the door member 14 other than the top surface 68. The bumper 130 of the decelerator assembly 32 is positioned so as to cushioningly abut the body member 70 of the roller assembly 20 when the door member 22 is located at the fully open position B.

The present inventive partition panel assembly reduces the number of parts typical of support track assemblies associated with partition panel assemblies, and further reduces the skill required for installation thereof. Moreover, the present inventive partition panel assembly reduces the velocity of an included sliding door, thereby reducing noise associated with operation of the door and increasing the operating life of components of the partition panel assembly.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A partition panel assembly defining an ingress and egress opening therein, comprising:
a stationary panel member having an exposed surface, wherein the exposed surface includes a longitudinally extending, downwardly exposed channel;
a door member slidably supported from the stationary panel member for movement between a closed position, wherein the door member covers the ingress and egress opening of the partition panel assembly, and an open position, wherein the door member allows ingress and egress through the opening; and
a door member support assembly, comprising:
a roller assembly operably coupled to the door member and including at least one roller; and
a support member having an upward extending arm received within the channel of the stationary panel member, a downwardly extending arm abutting the exposed surface of the stationary panel member, and a track portion supporting the roller of the roller assembly such that the door member is slidably supported from the stationary panel member.

2. The partition panel assembly of claim 1, wherein the channel of the stationary panel member is located within a recess, and wherein the downwardly extending arm of the support member is located within the recess when the support member is assembled with the stationary panel member.

3. The partition panel assembly of claim 1, wherein the support member comprises a single piece.

4. The partition panel assembly of claim 1, wherein the downwardly extending arm of support member includes a plurality of apertures spaced longitudinally therealong, and that receive mechanical fasteners therein that secure the support member to the stationary panel member.

5. The partition panel assembly of claim 1, wherein the roller assembly includes at least a pair of spaced apart rollers, and wherein the track portion includes a pair of spaced apart track rails that support the spaced apart rollers of the roller assembly.

6. The partition panel assembly of claim 1, wherein the door member support assembly further includes:
an adjustment assembly operably coupling the door member with the roller assembly, wherein the adjustment assembly is adjustable to allow leveling of door member with respect to the stationary panel member.

7. A sliding door support assembly adapted to slidably support a door member from a stationary partition panel such that the door member is supported from the stationary panel member for movement between a closed position, wherein the door member covers an ingress and egress opening adjacent the stationary partition panel, and an open position, wherein the door member allows ingress and egress through the opening, the sliding door assembly comprising:
a roller assembly including at least one roller;
an adjustment assembly operably adapted to couple a door member with the roller assembly, wherein the adjustment assembly is adjustable to allow leveling of the door member with respect to a horizontal plane; and
a support member having an upward extending arm received within a downwardly exposed channel of a stationary panel member, a downwardly extending arm abutting the stationary panel, and a track portion supporting the at least one roller of the roller assembly.

8. The sliding door support assembly of claim 7, wherein the support member comprises a single piece.

9. The sliding door support assembly of claim 7, wherein the downwardly extending arm of support member includes a plurality of apertures spaced longitudinally therealong and adapted to receive mechanical fasteners therein to secure the support member to a stationary panel member.

10. The sliding door support assembly of claim 7, wherein the roller assembly includes at least a pair of spaced apart rollers, and wherein the track portion includes a pair of spaced apart track rails that support the spaced apart rollers of the roller assembly.

11. A partition panel assembly, comprising:
a stationary panel member;
a door member having an exposed surface;
a track member supported by the stationary panel member;
a support assembly slidably supporting the door member from the track member between a fully open position and a fully closed position; and
a decelerator assembly including a spring member secured to the track member and adapted to frictionally engage the exposed surface of the door member when the door member is proximate a select one of the fully open position and the fully closed position, thereby decreasing a velocity of the door member prior to the door member reaching the select one of the fully open position and the fully closed position.

12. The partition panel assembly of claim 11, wherein the decelerator assembly includes a body portion that engages the track member, and wherein the spring member is operably coupled to the body portion.

13. The partition panel assembly of claim 12, wherein the track member includes a pair of space apart track rails, and wherein the body portion includes a pair of spaced apart teeth that engage the respective track rails of the track member.

14. The partition panel assembly of claim 13, wherein the decelerator assembly further includes at least one set screw that is threadably received within an aperture in the body portion and abuts the track member, thereby fixing the location of the decelerator assembly with respect to the track member.

15. The partition panel assembly of claim 11, wherein the position of the spring member is adjustable, thereby allowing adjustment of a force exerted by the spring member on the door member.

16. The partition panel assembly of claim 15, wherein the decelerator assembly includes a body portion that engages the track member, the spring member includes an elongate aperture and is adjustably coupled to the body portion by a mechanical fastener that extends through the elongate aperture, and wherein the amount of force exerted by the spring member on the door member is controlled by adjusting the location of the spring member with respect to the body portion.

17. The partition panel assembly of claim 11, further including:
an abutment plate coupled to a top surface of the door member and positioned so as to be frictionally engaged by the spring member.

18. The partition panel assembly of claim 11, further including:
a bumper member positioned to abut a side surface of the door member when the door member is the select one of the fully open position and the fully closed position.

19. The partition panel assembly of claim 11, wherein the spring member comprises a leaf spring.

20. A decelerator assembly adapted to slow the sliding movement of a door member slidably supported from a track member supported by a stationary panel member as the door member approaches a select one of a fully open position and a fully closed position, the decelerator assembly comprising:
a body portion adapted to be secured directly to the track member; and
a spring member operably coupled with the body portion and adapted to frictionally engage an exposed surface of a door member when the door member is proximate a select one of a fully open position and a fully closed position, thereby decreasing a velocity of the door member prior to the door member reaching the select one of the fully open position and the fully closed position.

21. The decelerator assembly of claim 20, further including:
at least one set mechanical fastener that is threadably received within an aperture in the body portion and that is adapted to abut a track member, thereby fixing the location of the decelerator assembly with respect to the track member.

22. The deceleration assembly of claim 21, wherein the body portion includes a plurality of teeth adapted to engage a track rail of a track member.

23. The decelerator assembly of claim 20, wherein the position of the spring member is adjustable, thereby allowing adjustment of a force exerted by the spring member on a door member.

24. The decelerator assembly of claim 23, wherein the spring member includes an elongate aperture and is adjustably coupled to the body portion by a mechanical fastener that extends through the elongate aperture, and wherein the amount of force exerted by the spring member on a door member is controlled by adjusting the location of the spring member with respect to the body portion.

25. The decelerator assembly of claim 20, further including:
a bumper member positioned to abut a side surface of a door member when the door member is at a select one of a fully open position and a fully closed position.

26. The decelerator assembly of claim 20, wherein the spring biased member comprises a leaf spring.
